(19) United States
(12) Patent Application Publication
(10) Pub. No.: US 2003/0141126 A1
(43) Pub. Date: Jul. 31, 2003

(54) Electric bicycles and retrofit kits

(75) Inventors: Marcus Hays, Los Angeles, CA (US); Mark Concha, Los Angeles, CA (US); Ron Holder, Irvine, CA (US); Greg Rhoads, Irvine, CA (US); Bohimel Mrazek, West Linn, OR (US)

Correspondence Address: PERKINS COIE LLP, POST OFFICE BOX 1208, SEATTLE, WA, 98111-1208, US

(73) Assignee: ZVO, Inc.

(21) Appl. No.: 10/259,201

(22) Filed: Sep. 27, 2002

Related U.S. Application Data
(60) Provisional application No. 60/326,149, filed on Sep. 28, 2001.

(51) Int. Cl. B62K 11/00

(52) U.S. Cl. 180/207; 180/220

(57) ABSTRACT

A bicycle has an electric motor and attached single or multiple sprockets, gears, chains, belts, shafts and mounting brackets. Outer sprockets are independently turned by either the motor or the pedals, and these outer sprockets then turn an inner sprocket which drives the drive chain and turns the rear wheel. Either the motor or the pedals, or both, may propel the bicycle. The vehicle also includes a means for detecting gear shifting and thereupon reducing power to the motor for a short time interval.

This Application claims priority to U.S. Patent Application Serial No. 60/326,149, filed Sep. 28, 2001, and now pending. Serial No. 60/326,149 is incorporated herein by reference.

The field of the invention is electrically powered vehicles, and especially bicycles, tricycles and quadracycles (collectively defined here and in the claims as “bicycles”). The invention further relates to a system or kit, and methods for converting a pedal powered bicycle into an electric motor powered bicycle.

### BACKGROUND OF THE INVENTION

Electric bicycle motor power methods typically drive wheels via friction, chains, belts, shafts or direct drive hub motors. However, in each example the motor system is separate from, or additional to the pedal system. Not utilizing the existing pedal components result in redundant sprockets, chains, added complexity, added weight and unnecessary cost. Maintaining alignment of the motor, sprockets, and other components has also been problematic in electric bicycles.

Pedal drive line components typically include two pedals, two cranks, a chainwheel or chainwheels, sprockets (single or multiple) and are typically linked via chan, belt or shaft to gear or multiple gears attached to a driven wheel.

While various electric bicycles have been proposed and used, engineering challenges remain in providing a reliable high performance electric bicycle.

### SUMMARY OF THE INVENTION

The present system and method applies to any or all of the above pedal drive-line components.

Further, the present system and method integrates the pedal and motor drive line without the need for a special purpose bicycle design, a permanent mounting system or welded fixtures.

By utilizing the existing pedal system and linking its various components, weight, complexity and cost are reduced. And in cases where the bicycle offers multispeed gearing, this method offers the additional advantage of being able to link these gears to the motor and to the pedals. Multispeed gearing enhances the performance of the electric bicycle. As a retrofit or “kit”, or as an original manufacture, the existing pedal system and gears are linked with the motor.

By integrating the existing pedal system with the motor and by linking the various pedal components with the motor, performance of the electric bicycle is significantly enhanced. Existing electric bicycles have difficulty climbing hills or grades. By integrating the existing pedal components and especially multispeed gearing, this method benefits from these gears being used as a transmission to allow enhanced ascent of hills or grades. No other “kit” utilizes this method. In this separate aspect of the invention, an electric motor provided in a kit drives the rear wheel(s) of the bicycle through the existing gear system on the bicycle. Consequently, there is less need to match the torque characteristics of the motor over the entire load range.

A method for attaching the kit to the frame includes plates or brackets that hold or sandwich the motor between the bottom bracket. The set of plates or brackets holding the motor are also preferably secured to the bicycle frame at the bottom bracket end. The plates or brackets position the motor between the bottom bracket ends and a clamp also attaches the motor to a down tube, cross tube, seat tube or any other location that prevents the motor from rotating when torque is exerted on the pedals by the operator or when torque is exerted when the motor is engaged. The plates or brackets hold the motor in place and also position the motor to align the motor sprocket with the drive chain. By tightening the bottom bracket nuts, the motor plates or brackets are tightened against the bicycle frame which in turn secures the motor system to the bicycle. (This allows for a retro-fit, or “kit” methodology). This method eliminates the need for specially designed frames, permanent mounting methods, and permanent or welded fixtures. The bicycle owner can therefore remove the kit from one bicycle and install the kit onto another bicycle. In this separate aspect of the invention, the mounting plates allow the electric motor to be added onto an ordinary bicycle, using common tools, and without the need to modify the bicycle via welding, etc.

The set of plates or brackets holding the motor are also preferably positioned in such a way as to align the motor output sprocket with the driven wheel sprocket and the pedal chainwheel. The motor plates are designed to accommodate any bottom bracket end dimension and or any bottom bracket end type, including cartridge or open bearing spindle variety. In this separate aspect of the invention, alignment of the sprockets is maintained, avoiding premature wear on the sprockets and chains (or equivalent drive means such as belts and pulleys).

The motor is preferably located at or near a low point of the bicycle, so that the weight of the motor is optimized relative to the bicycle center of gravity. In this separate aspect of the invention, bicycle stability and handling are improved. The battery may also be located at a low point, near or on the motor.

Another unique method for attaching the kit to the bicycle frame accommodates custom frames that may not be compatible with the bottom bracket end location. If the bottom bracket mounting location is non standard or incompatible with the standard bottom bracket plate design, alternative plate and bracket designs allow the motor to be secured to the bicycle seat tube, cross tube, or down tube. In either case, the plates or brackets secure the motor to position the chains in correct alignment thus successfully integrating the existing pedal drive line chains, belts or belts, shaft or shafts with the retrofit or kit system. This method integrates with any type of gear or transmission system, including derailers, hubs, or planetary variety.

In another separate aspect of the invention, an electrically or electronically actuated circuit, relay or mechanical switch momentarily interrupts motor power to the driven wheel. This is useful because continuous and moderate to high power at the rear or driven wheel during e.g., hill climbing or under heavy loading, makes shifting difficult or impossible (at least with most bicycle gearing systems). The system interrupts the motor power for a duration long enough to allow the bicyclist to shift gears without decelerating. This allows the bicyclist to maintain maximum forward momentum. The system preferably senses either motor current draw or torque on the drive sprocket or chain, and also senses initiation of gear shifting. Upon sensing the presence or threshold values of gear shift initiation alone, or gear shift initiation together with a motor condition (such as current or torque) the system reduces or stops current to the motor for a selected time interval. The time interval is sufficient to allow for completion of gear shifting, typically from 0.5-5 or 1, 2, or 3 seconds. The system may select from a table of interval values, or calculate an interval value, based on sensed input parameters including present gear condition, shift direction (up or down), pedal speed, bicycle speed or wheel rpm, torque loading, inclination angle, weight, etc. Sensors for detecting these parameters may be included and linked into the system, typically in a microprocessor or similar device in the motor controller.

The integration of motor with pedal drive components offers the advantage of reducing complexity, weight, and cost while increasing performance and battery efficiency. If the bicycle has multispeed gears, this method can utilize these gears to enhance the torque and/or speed of the motor.

The invention may be provided as either a retrofit kit or as a complete bicycle. In both cases, there is a motor, one or more sprockets attached to the motor, a gear or gears attached to the driven wheel, a chain or chains, belt or belts, shafts or shafts and mounting brackets or mounting plates which ultimately connect the motor and pedals to the driven wheel. Depending on the model, the motor is linked via chain, chains, belt or belts, shaft or shafts to the pedal sprocket, sprockets, chainwheel or chainwheels. In some cases two chains, belts or shafts may be used and in others only one chain, belt or shaft is used. This applies to either single or multispeed bicycle configurations. In both cases, the sprockets or sprockets attached to them or can be mounted via one-way bearings, “freewheels”, or as a fixed sprocket or sprockets, gear, gears, or cog and cogs. More than one electric motor may also be used.

Most multispeed bicycles offer chan or belt tensioners. If the existing bicycle does not, an optional tensioner may be added.

The design of the bicycle frame may have very little or no affect on the mounting design, which is a universal design. Some bicycle frames are triangular in shape while others are curved tubes, while still others are longitudinal tubes with wheels suspended (or fixed) at either end. The bracket and plate method described accommodates all bicycle frame styles and configurations.

The invention resides as well in the subsystems, components and method steps described. It is an object of the invention to provide an improved electric bicycle, kit, components and methods.

### BRIEF DESCRIPTION OF THE DRAWINGS

In the drawings, wherein the same reference number indicates the same element in each of the views:

FIGS. 1A-1E are schematic side views of mounting configurations with the motor above the down tube.

FIGS. 2A-2E are schematic side views of mounting configurations with the motor below the down tube.

FIG. 3 is a right side view of a preferred design.

FIG. 4 is an enlarged view the motor and mounting plate shown in FIG. 3.

FIG. 5 is a left side view of the design shown in FIG. 3.

FIG. 6 is an enlarged view of the motor and mounting plate shown in FIG. 5.

FIG. 7 is a front view of the battery and motor shown in FIG. 3.

FIG. 8 is a rear view of rear wheel and chain shown in FIG. 3.

FIG. 9 is a schematic electrical diagram of a preferred design.

FIG. 10 is a schematic side view of an alternative design.

FIG. 11 is top view rotated 90 degrees of the design shown in FIG. 10.

FIG. 12 is a schematic side view of another alternative design.

FIG. 13 is top view rotated 90 degrees of the design shown in FIG. 12.

FIGS. 14-16 are designs similar to the design shown in FIG. 12, and with the motor located at alternate positions.

FIG. 17 is a side view of another alternative embodiment.

FIG. 18 is a bottom view thereof.

FIG. 19 is a front view thereof.

### DETAILED DESCRIPTION

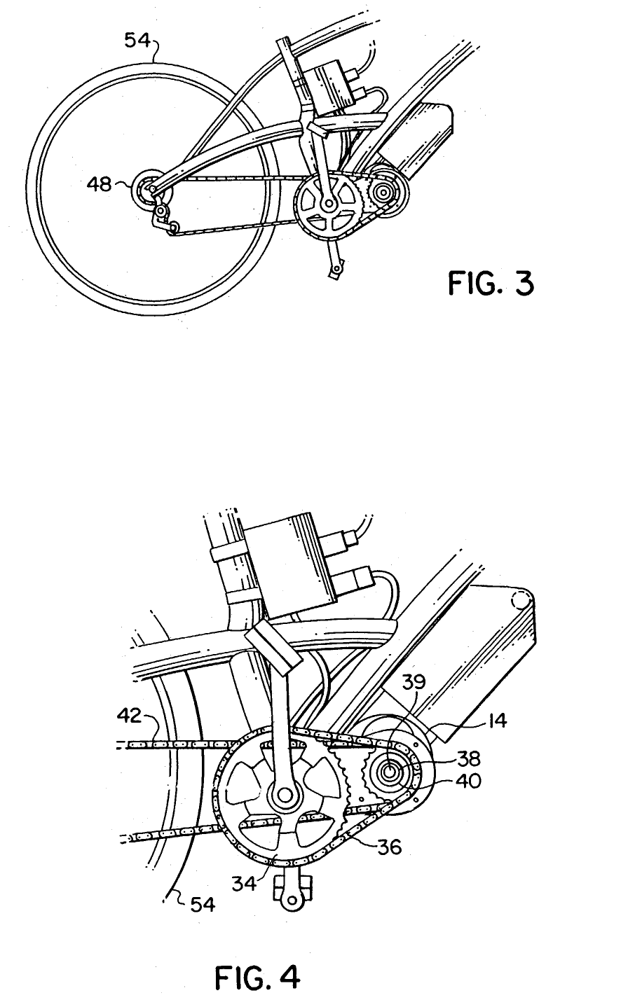

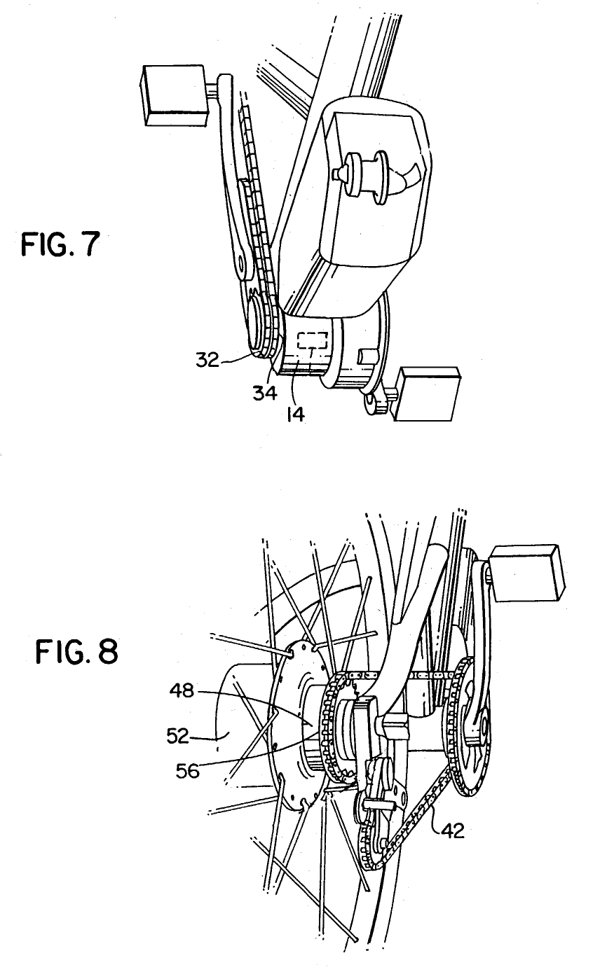

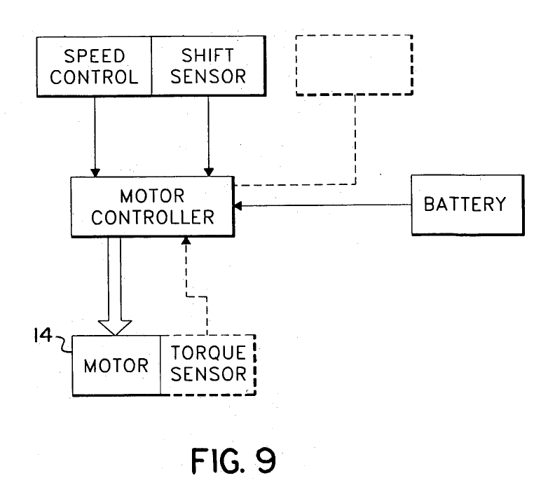

Referring to FIGS. 3-8, a first or inner motor sprocket 30 is attached to a first free wheel 38 on the drive shaft 39 of the motor 14. A drive chain 42 connects the sprocket 30 to the rear sprocket 56 at the rear hub 48. A second or outer motor sprocket 32 is supported on a second free wheel 40 on the first sprocket 30. When the motor is on, the shaft 39 drives the inner sprocket 30, drive chain 42, rear sprocket 56, and rear wheel 54 to propel the bicycle 10. The pedals 35, chain ring 34 and pedal chain 36 may remain still, via the outer free wheel 40. Consequently, the pedals need not move when the motor is on and propelling the bicycle. Correspondingly, the motor is not turned when the rider is pedalling, so that the motor adds no drag, resistance or inertia, when it is off.

When the rider pushes on the pedals, the chain ring 34 drives the pedal chain 36 which turns the outer sprocket 32 (through the outer free wheel 40) in turn driving the inner sprocket. The inner sprocket drives the drive chain to propel the bicycle independent of the motor. As the inner sprocket is on the inner free wheel, the motor shaft remains still when the pedals are used to propel the bicycle. Consequently, either the motor or the pedals (or both) may propel the bicycle, without having the pedals needlessly turn the motor, and without having the motor needlessly drive the pedals.

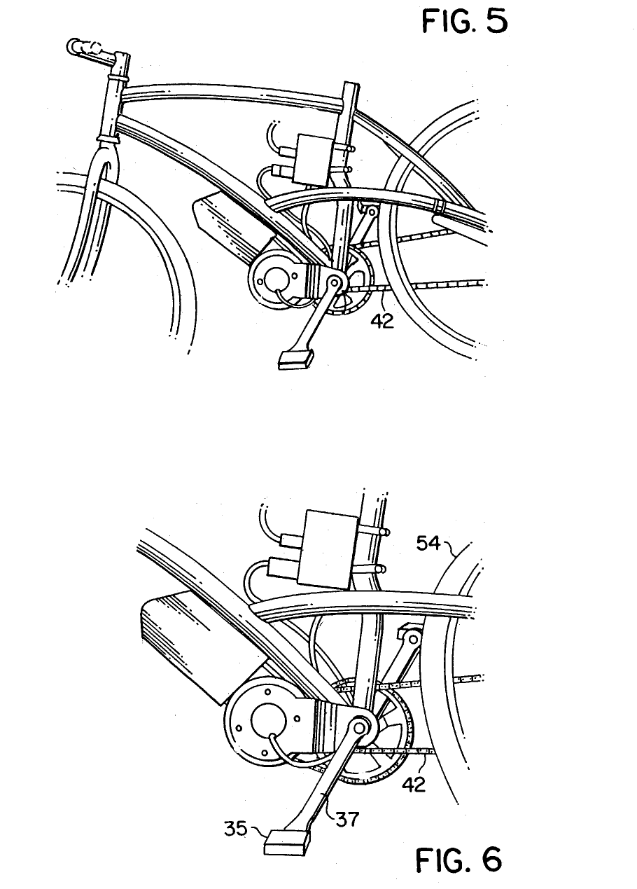

As shown in FIGS. 3 and 5, the motor and battery are low on the frame. This keeps the center of gravity of the bicycle low and improves stability and handling. Referring to FIG. 6, the mounting plates are preferably equal to or shorter than the length of the pedal crank arms 37. The motor is mounted on the frame to preferably minimize the distance between the outer motor sprocket and the chain ring. For mountain bicycles, the battery and motor may be mounted higher up on the frame, to reduce potential for damage by collision with obstacles. The space between the inner motor sprocket and the outer motor sprocket or freewheel may be adjustable to accommodate varying widths of bottom bracket ends and bottom bracket cartridges.

The left and right motor mounting plates have adjustment holes, slots and tensioning screws that allow the motor and the adjoining sprockets to be moved laterally. This allow adjustment to accommodate the spacing differential between the driven wheel sprocket and the pedal chain ring thus making the system universal to all pedal driven vehicles. This adjustment design also allows for both the driven wheel chain and the pedal chain to be adjusted simultaneously and without the need for separate tensioners, eliminating cost, reducing friction and improving efficiency and ease of maintenance due to chain stretch that occurs over time. Once properly located, the motor is locked in place in the slots or slotted openings via clamp nuts.

The lateral position of the chain ring and rear sprocket may vary on different bicycles. Accordingly, the sprockets 30 and 32 are advantageously laterally moveable (left or right) e.g., 1-5 mm via threaded bosses, shims, washers, etc.

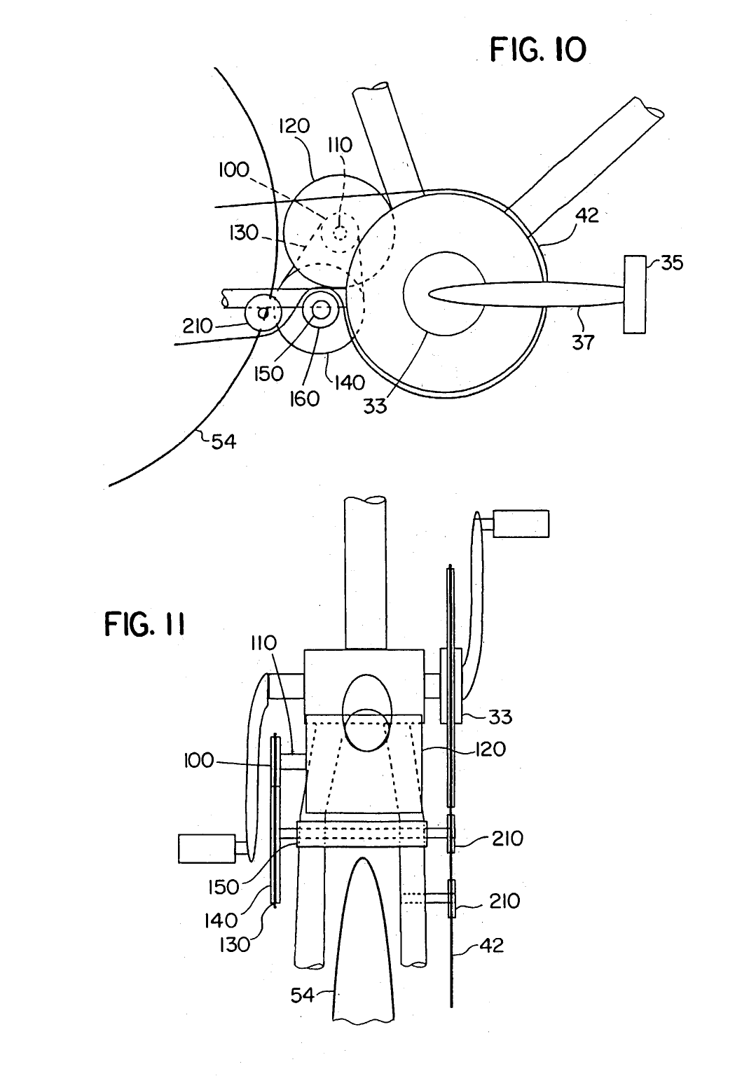

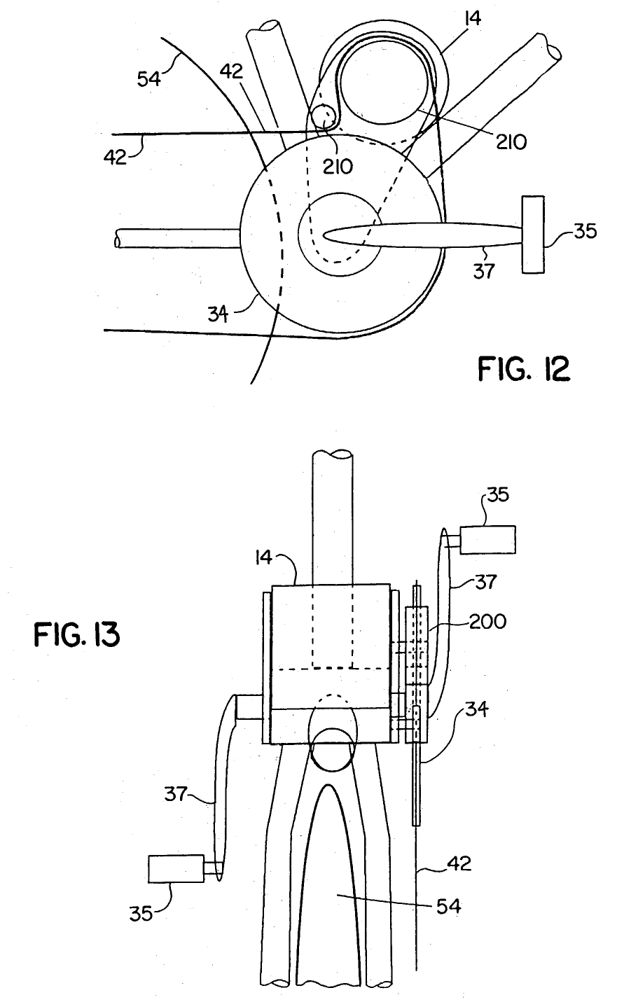

Referring to FIGS. 10 and 11, in a first single chain drive system, a motor sprocket 100 is attached to the drive shaft 110 of the motor 120. A drive chain 130 connects sprocket 100 to sprocket 140 (first stage of reduction). Sprocket 140 is fixed to a jackshaft 150 (sprocket 140 may also be a free wheel or clutch bearing) to transfer rotation of motor 120 to the other side of the bicycle. The jackshaft 150 is connected to drive sprocket 160 (a free wheel could be attached to jack shaft 150 spinning the opposite direction of sprocket 140, this would reduce friction). A drive chain 42 connects the chain ring 33, to the sprocket 160 the drive chain 42 raps over chain guide 210 to the gear cluster 52 at the rear hub 48 (the second stage of reduction) to propel the bicycle 10. Due to fact the chain ring 33 is fixed to a free wheel that spins freely when the motor is engaged, this allows use of the pedals independently or in conjunction with the motor. The pedals 35 and pedal crank arms 37 remain still, when only the motor is used.

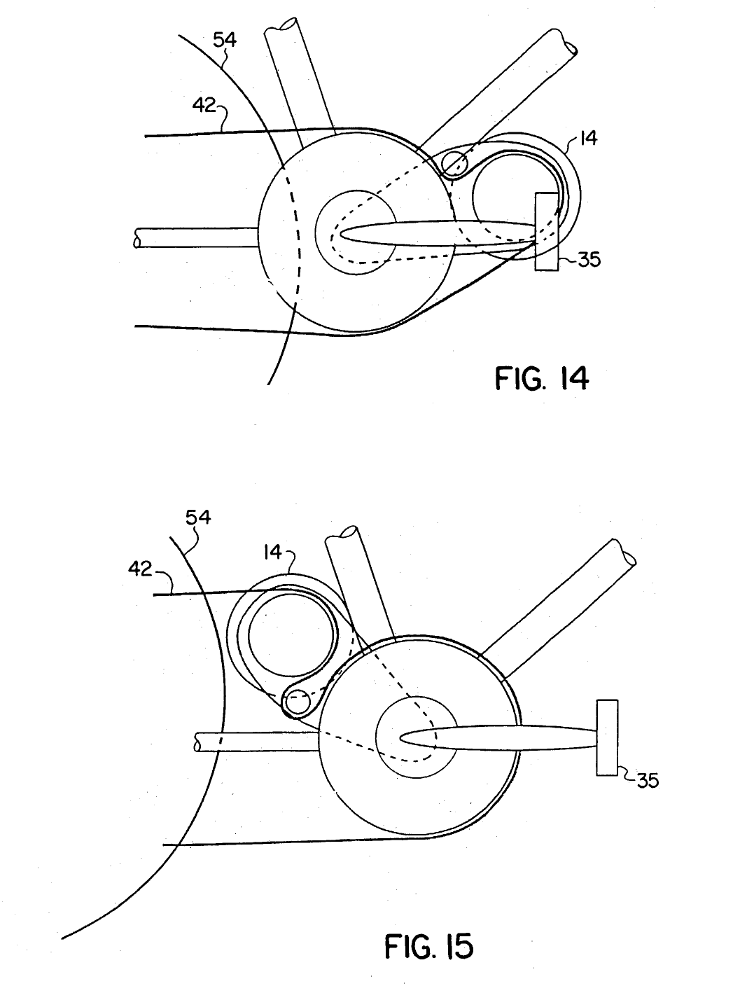

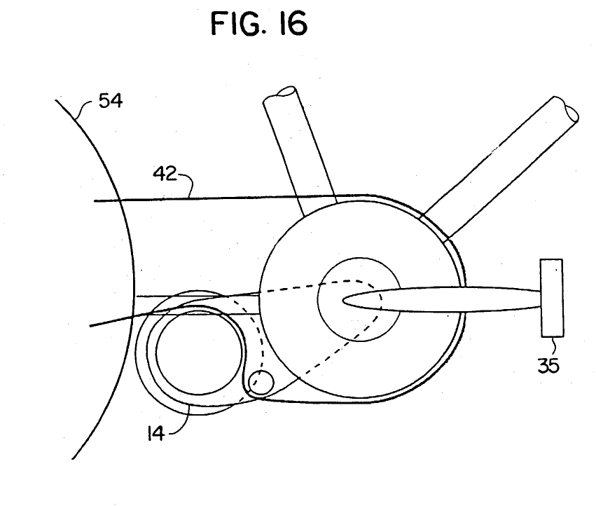

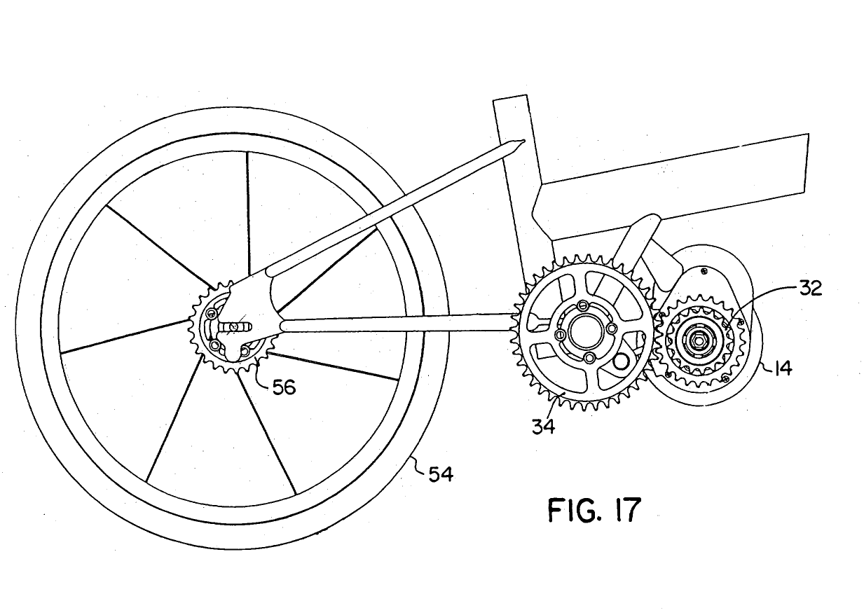

Referring to FIGS. 12-16, in another single chain drive system, the motor sprocket/free wheel 200 is attached to the drive shaft 39 of the motor 14. A drive chain 42 is wrapped around chain guide 210, connects sprocket/free wheel 200 to chain ring 33 to the gear cluster 52 or sprocket 56 at the rear hub 48. In this arrangement sprocket/free wheel 200, chain ring 33, and chain guide 210 are aligned. The chain guide 210 is repositioned for any of the positions shown in FIGS. 14-16.

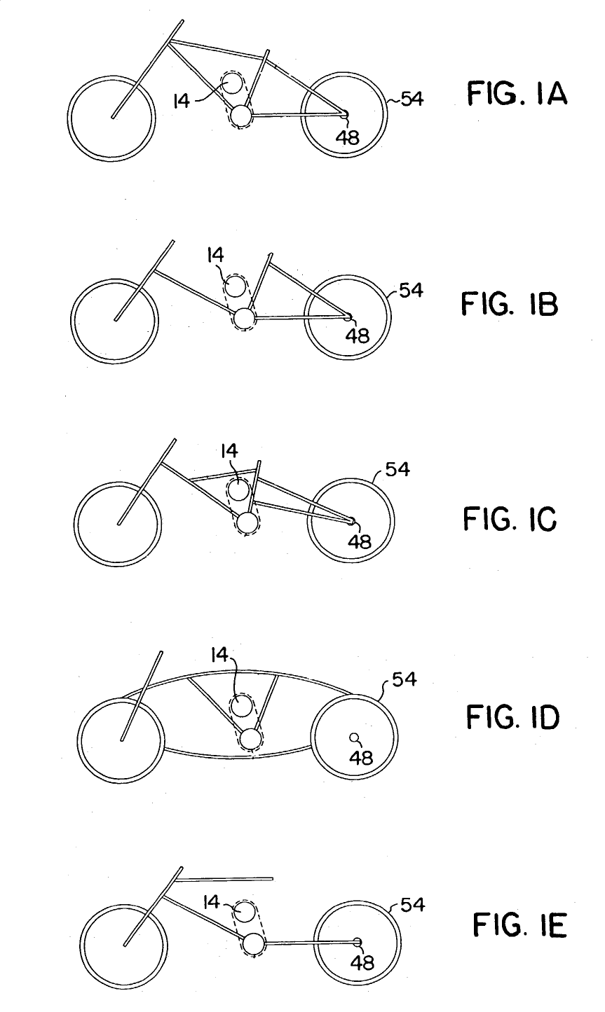

FIG. 1A shows a triangular bicycle frame with the motor mounted between the seat tube and the down tube.

FIG. 1B shows a step through frame with a similar motor mounting position.

FIG. 1C shows a full suspension frame with a similar motor mounting position.

FIG. 1D shows a reverse arc frame with a similar motor mounting position.

FIG. 1E shows a cantilever frame with a similar motor mounting position.

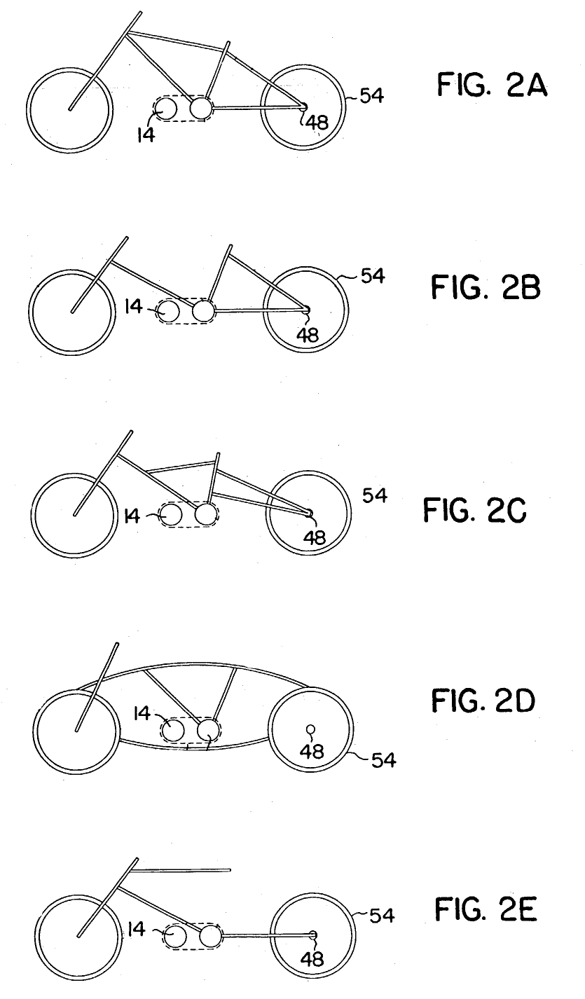

FIG. 2A shows a triangular bicycle frame with the motor mounted forward of the pedal chain ring and below the down tube.

FIG. 2B shows a step through frame with a similar motor mounting position.

FIG. 2C shows a full suspension frame with a similar motor mounting position.

FIG. 2D shows a reverse arc frame with a similar motor mounting position.

FIG. 2E shows a cantilever frame with a similar motor mounting position.

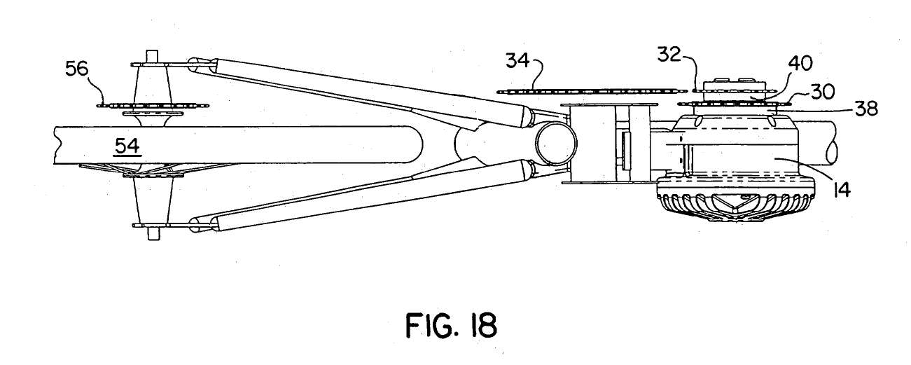

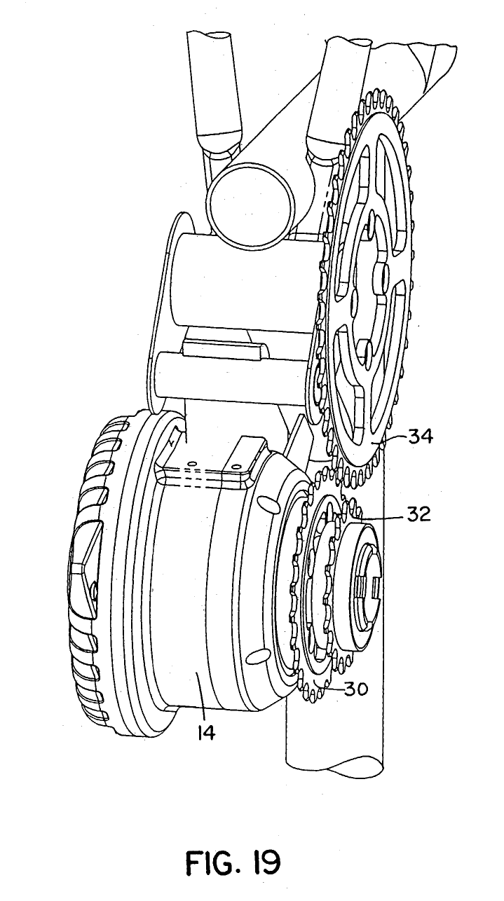

Turing to FIGS. 17-19, the outer or second motor sprocket 32 is aligned (front to back) with the chain ring34. The inner or first sprocket 30 is aligned with the rear sprocket 56. If a rear sprocket cluster is used, then the inner motor sprocket is aligned with a sprocket at or near the center (left to right) of the cluster.

1. An electrically powered vehicle comprising:
a frame;
at least one seat on the frame for supporting a rider;
a set of pedals rotatably supported on the frame;
a wheel rotatably attached to the frame;
an electric motor linked to the wheel and to the set of pedals.

2. The vehicle of claim 1 further comprising gear means associated with the wheel, for changing gear ratios between rotation of the set of pedals and the rear wheel, and with the electric motor linked to the gear means, to drive the wheel through the gear means.

3. The vehicle of claim 2 wherein the gear means comprises a cluster of sprockets of varying size.

4. The vehicle of claim 1 further including:
a first sprocket driven by the motor through a first freewheel;
a second sprocket driven by rotation of the first sprocket, through a second freewheel;
a chain ring joined to the set of pedals;
a rear sprocket associated with the wheel;
a first chain extending around the first sprocket; and
a second chain extending around the second sprocket and the chain ring.

5. The vehicle of claim 1 further comprising a motor controller and an electric power source connecting to the motor, with the motor controller including gear shift sensing means for reducing power to the motor when gear shifting is sensed.
